(19) United States
(12) Patent Application Publication
(10) Pub. No.: US 2012/0092958 A1
(43) Pub. Date: Apr. 19, 2012

(54) Estimation of anisotropy from compressional waves from array sonic waveforms in well logging

(75) Inventor: Sandip Biswas, Austin, TX (US)

(73) Assignee: Geobiz Inc., Sugar Land, TX (US)

(21) Appl. No.: 12/925,259

(22) Filed: Oct. 18, 2010

(51) Int. Cl. G01V 1/50

(52) U.S. Cl. 367/31

(57) ABSTRACT

The present invention provides an improved method for estimating anisotropic formation from wave data using present-day logging tools that allow for the detection of compressional wave splitting to identify fracture direction. This methodology for analyzing compressional waveforms uses the Alford rotation method.

### CROSS-REFERENCES TO RELATED PUBLICATIONS

This application claims the earlier filing date of the provisional application filed with provisional patent application No. 61/278,481 with date Oct. 21, 2009.

The application also references the following:
1. Leonardon, E G, Logging, sampling and Testing” in Carter, DV (ed): History of Petroleum Engineering, New York City: American Petroleum Institute (1961): 493-578
2. Tsavankin, I., Seismic Signatures and Analysis of Reflection Data in Anisotropic Media, V 29, Elsevier Science Ltd., 2001, pg. vii
3. Alford, R. M, 1986, “Shear Data in the Presence of Azimuthal Anisotropy, Dilley, Texas”, Proceedings of 56th SEG Annual Meeting, p. 476-479

### FEDERALLY SPONSORED RESEARCH OR DEVELOPMENT

N/A

### JOINT RESEARCH AGREEMENT

N/A

### SEQUENCE LISTING

N/A

### BACKGROUND OF THE INVENTION

1. Field of the Invention

This invention relates to investigation of earth formation and, more particularly, to a method for determining properties of earth formations, such as fracture systems, using compressional wave data recorded by present-day sonic well-logging tools.

2. Background of the Invention

The present invention provides an improved acoustic well-logging method for estimating anisotropic formations in well-logging; particularly, it relates to an improved method for analyzing and interpreting well-logging data by using compressional instead of shear wave anisotropy. The present invention takes advantage of modern technology to make oil exploration and exploitation more efficient and productive.

The production of hydrocarbons from subsurface formations commences by drilling a borehole through the earth to a target depth, to penetrate a subsurface reservoir considered to be hydrocarbon bearing. Finding and producing hydrocarbons efficiently and effectively requires understanding the rocks and fluids of a reservoir and of surrounding formations. Three basic oilfield measurements-electromagnetic, nuclear and acoustic—have been devised to achieve this end. With advances in tool design and in data acquisition, processing and interpretation, each measurement type has evolved to produce more and different information. None, perhaps, has evolved more than the acoustic, or sonic, measurement.

First sonic tool was introduced in 1951, by Humble Oil Company. In their early days, sonic measurements were relatively simple. They began as a way to match seismic signals to rock layers. Today, sonic measurements reveal a multitude of reservoir and well bore properties. They can be used infer primary and secondary porosity, permeability, lithology, mineralogy, pore pressure, invasion, anisotropy, fluid type, stress magnitude and direction, the presence and alignment of fractures and the quality of casing-cement bonds.

The acoustic waves recorded by a sonic logging tool depend on the energy source, the path they take and the properties of the formation and the borehole. In wireline logging, there are two primary types of sources, monopole and dipole.

From the borehole, various physical, chemical and mechanical properties are “logged”. Logged data is analyzed to determine various rock properties, like, porosity, permeability, mechanical properties, depth of the reservoir. One such logging technique commonly used in the industry is acoustic logging. Acoustic tool was first introduced in 1951 by Humble Oil Company. At first, sonic logging tools were used to provide a continuous velocity measurement in a borehole. These measurements were used to achieve better time-depth tie.

With the advent of time, sonic logging has become much more complex. Presently, multiple sectored receivers generate a arrays of sonic data. These arrays are then analyzed to produce:

a) Slowness values for compressional, shear and stoneley waves

b) Porosity of logged sections

c) Permeability of logged section

d) Dynamic rock mechanical properties, like bulk, shear and young's moduli

e) Direction of maximum stress from cross-dipole tools

### BRIEF SUMMARY OF INVENTION

The present invention provides an improved method for estimating anisotropic formation from wave data using present-day logging tools. Up until the present method, shear splitting has been used to identify fracture direction. Shear wave anisotropy, however, can only be used to depict the present-day stress regime of the fracture. Unfortunately, the present-day stress regime of the fracture may not coincide with the paleostress regime which actually caused the fracture.

Although the polarization of compressional waves along anisotropic planes is documented for seismic waves, it has been assumed that compressional waves are non-dispersive, that they do not “split” like shear waves, in the well-logging field.¹ In contrast, however, the present invention demonstrates that compressional waves split very much like shear waves along fracture planes and provides the method for analyzing compressional wave anisotropy.

Up until the present method, the well-logging industry has analyzed data by calculating the fracture from direct azimuth of shear waves. Using this methodology, however, may be misleading and does not take advantage of the modem tools and technology now available in this sector. The present method takes advantage of the sensitivity of modem technology to get a more accurate and complete result. Previous well-logging instruments could only provide data for perpendicular elongation of the fracture—shear wave stress. Innovations in the field, however, can provide data for compressional waves that are more subtle, longitudinal elongations along the matrix. Although the instruments have become more updated, the methodology for analyzing the data has not. Compressional waves have been ignored in well-logging until now.

As the present method demonstrates, the data from compressional waves should not be dismissed. Shear energy anisotropy only represents the present day stress regime; the present day stress regime may or may not reflect the stress regime that actually caused the fracture. Stress fields change with time as does the direction of the stress applied. Therefore, calculating fracture from a direct azimuth of the shear stress provides an inaccurate stress history of the basin, causing errors in well placement and leading to more costly operations. In contrast, the present method provides a more complete and accurate picture of the stress history of the basin by using compressional anisotropy azimuth. Since the present method leads to more surety in fracture cause, well placement will be more accurate in the field.

### BRIEF DESCRIPTION OF THE DRAWINGS

FIG. 1. Output from a Pressure Transducer of a Raw Compressional Waveform

FIG. 2. Variation in the Four Receivers' Output of Raw Root Mean Square (RMS) Energy highlighting the need for normalization

FIG. 3. Normalization of the Four Receivers' Output of Raw RMS Energy (FIG. 2)

FIG. 4. Compressional Waveform after Depth Stacking, Filtering, Muting, and Normalization of Raw Compressional Waveform (FIG. 1)

FIG. 5. Side-by-side Comparison of Shear and Compressional Anisotropy Azimuth showing that Shear and Compressional waves do not always give the same result.

### DETAILED DESCRIPTION OF INVENTION

To further understanding of the present invention, the following discussion is provided. Shear wave energy propagates in a direction perpendicular to the stress motion. When shear waves encounter anisotropic formations, they undergo shear wave “splitting” (the shear wave partitions into two components). Anisotropic formations can be caused by cracks and fractures, for example. The basins caused by these fractures may be indicative of an oil reservoir. As a result, shear wave splitting is used to determine fracture direction to identify the characteristics of the basin.

Moreover, in well-logging, it has been assumed that compressional waves are non-dispersive—that they do not split like shear waves. Compressional wave energy propagates longitudinally along the matrix. Older technologies could not provide accurate data on compressional wave propagation because it results in a subtler disruption. Present day tools, however, can provide accurate data of compressional wave anisotropy.

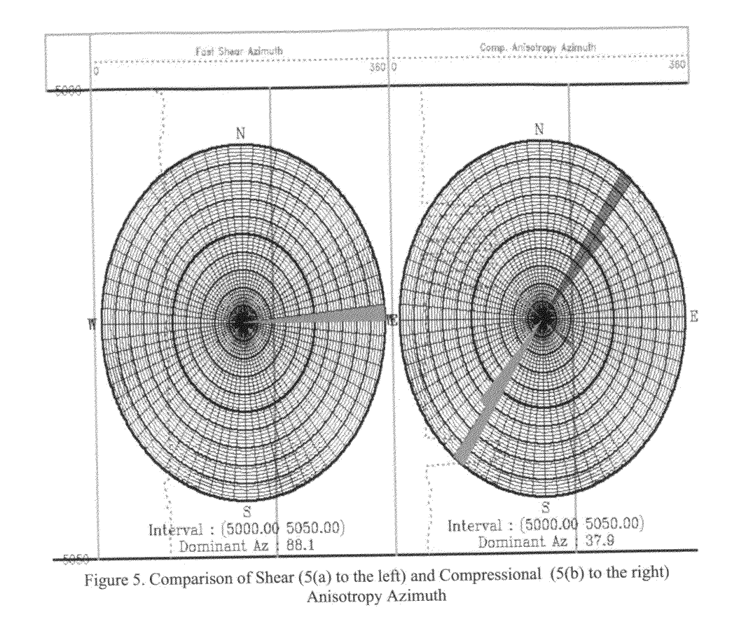

Compressional wave anisotropy provides an alternative and perhaps a replacement of shear wave anisotropy. Although the current standard, use of shear wave anisotropy depicts only the present day stress regime of the fracture. Since the present-day stress regime may not accurately represent the stress that actually caused the fracture, the conclusions drawn from the shear wave anisotropy analysis may be inaccurate and do not fully utilize the capabilities of modern well-logging tools. Furthermore, the present method demonstrates that compressional waves split along fracture planes much like shear waves and actually provide a more accurate depiction of the basins since compressional wave anisotropy analysis depicts the stress regime that caused the fracture in addition to the present-day stress regime. FIG. 5 shows azimuthal anisotropy from both a compressional and shear wave train. FIG. 5 demonstrates that anisotropy azimuth seen by compressional waves may be significantly different from that seen by shear waves.

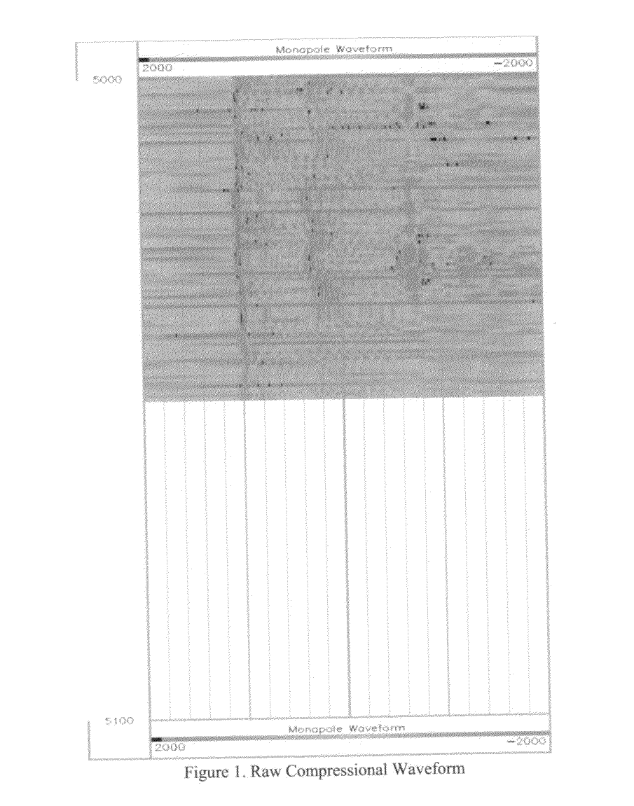

Anisotropy seen by compressional waves is a very subtle phenomenon. Raw data for compressional waveforms includes waves with a wide range of frequencies. Moreover, the frequency spectra of the waves at the same depth are not identical. Prior to analysis, therefore, the waveforms need to be filtered in the frequency domain in exactly the same window. Additionally, raw recorded waveforms also contain spurious and redundant events in the time domain. Prior to analysis, therefore, muting must also be used to retain relevant data and to eliminate unnecessary events. FIG. 1 shows a compressional waveform recorded by a logging tool.

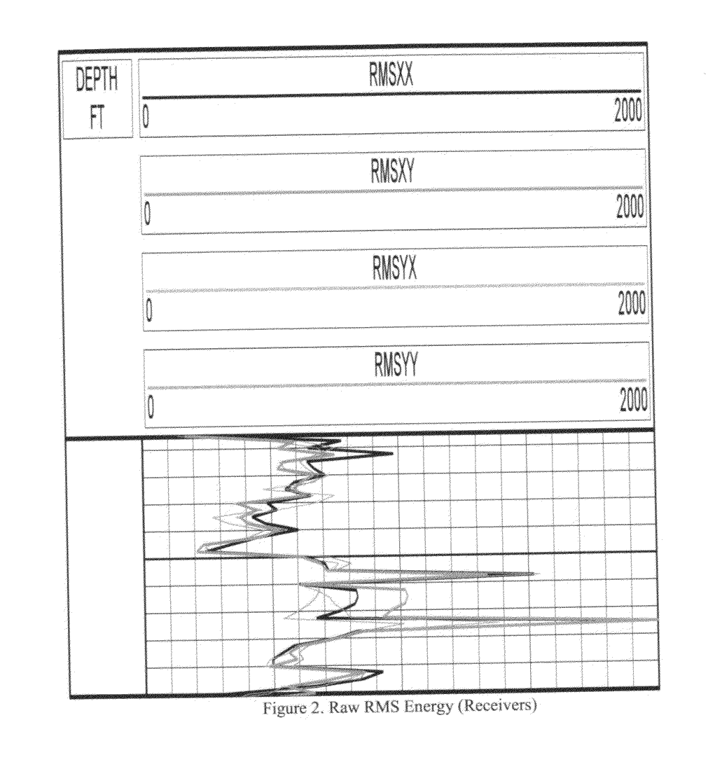

To begin the analysis, it must be noted that all waveforms, including compressional waveforms, recorded by a logging tool are affected by certain variances that need to be accounted for before any estimation of anisotropic azimuth can be calculated. Variances in recorded waveforms may be caused by tool eccentricity while logging or receiver output variations, for example. In order to account for these variances and correct for them when analyzing the data, Step 1 requires calculating the RMS energy of each compressional waveform. FIG. 2 depicts the RMS evergy output of 4 receivers at the same depth. Furthermore, FIG. 2 shows the wide variation in energy output of the four, sectored receivers at the same depth.

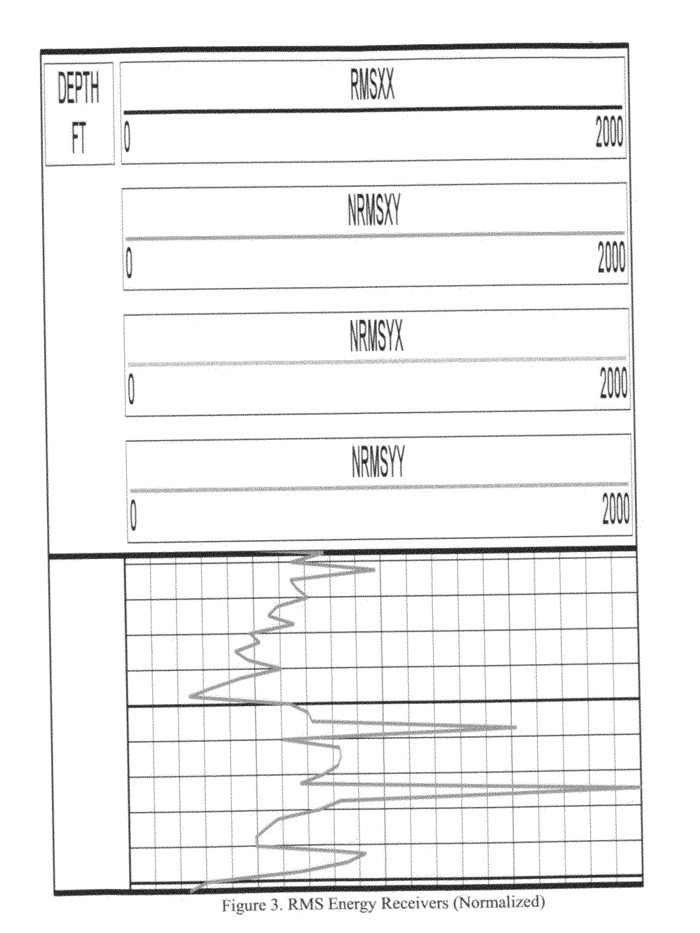

Step 2 requires normalizing the waveforms so that all four sectored have the same output energy at the same depth. In order to normalize the data, one of the four receivers must be used as a standard. FIG. 3 shows the RMS energy output of the same receivers as shown in FIG. 2 after normalization. Furthermore, FIG. 3 shows that the output variations in the receivers have been corrected.

Step 3 requires depth averaging to achieve stacking of waveforms. Since, in well logging, there are no stacking mechanisms for acoustic waveforms at the same depth point currently available, depth averaging is used to achieve stacking of waveforms. No significant error results from this because anisotropy is a slow phenomenon; azimuth of anisotropy changes very slowly.

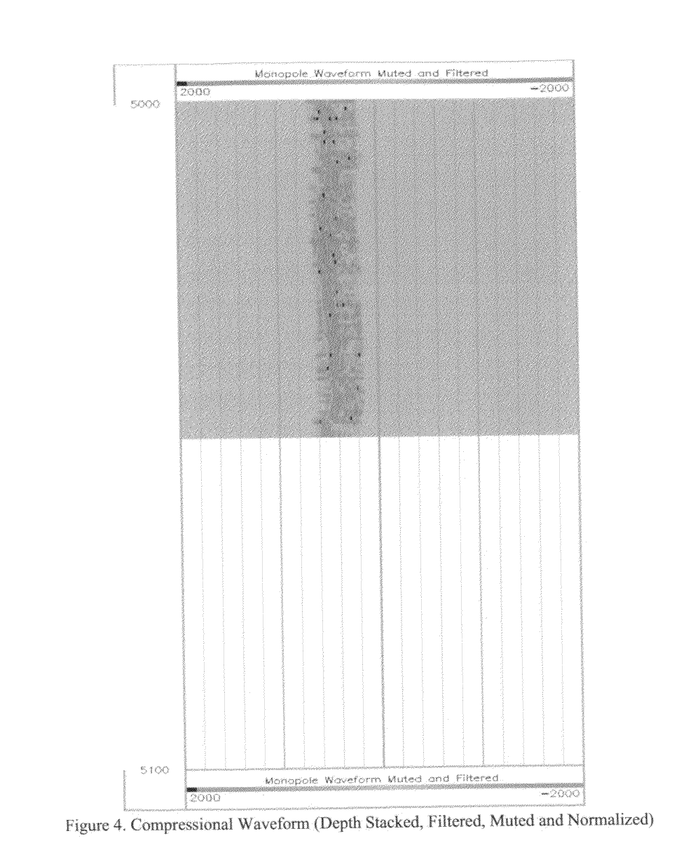

Step 4 requires the rotation of the final pre-processed waveform, as shown in FIG. 4, using the Alford rotation method. The Alford rotation method is accomplished using the following equations (1)-(7), where the waveform is rotated in steps of 1 degree from 0 to 90 degrees and where the RMS energy of the rotated waveforms is noted for every degree.

s1=sin²(theta) (1)

s2=cos²(theta) (2)

s3=sin(theta)*cos(theta) (3)

x[0]=xx*s2+yy*s1+(xy+yx)*s3; (4)

x[1]=xy*s2−yx*s1+(yy−xx)*s3; (5)

x[2]=yx*s2−xy*s1+(yy−xx)*s3; (6)

x[3]=yy*s2+xx*s1−(xy+yx)*s3; (7)

Once the waveforms have been rotated, the waveforms may then be used to determine the fracture characteristics.

What is claimed is:

1. A method for estimating anisotropic formations from compressional wave data, using present-day well-logging apparatus such as sectored compressional receivers, comprising the steps of:
a) normalizing the RMS amplitude of the compressional event;
b) depth averaging compressional data resulting in a complete muted waveform;
c) rotating the waveforms;
d) analyzing the rotated waveforms to determine the fracture characteristics;

2. The method as defined in claim 1, where compressional wave data further comprises the assertion that compressional waves split in anisotropic media;

3. The method as defined in claim 1, where the present day well logging apparatus comprises sectored compressional receivers equally spaced around 360 degrees collecting orthogonal wave components that have traveled through formations;

4. The method as defined in claim 1, where claim 1(a) further comprises isolating the compressional event in the raw data;

5. The method as defined in claim 1, where claim 1(a) further comprises converting the time series data into the frequency domain using Fourier transforms

6. The method as defined in claim 1, where claim 1(a) is achieved by using one receiver as a standard;

7. The method as defined in claim 1, where claim 1(c) is achieved by using the Alford rotation method.
